(19) United States
(12) Patent Application Publication
(10) Pub. No.: US 2017/0232966 A1
(43) Pub. Date: Aug. 17, 2017

(54) VEHICLE CONTROL DEVICE, VEHICLE CONTROL METHOD, AND VEHICLE CONTROL PROGRAM

(71) Applicant: Honda Motor Co.,Ltd., Tokyo (JP)

(72) Inventors: Atsushi ISHIOKA, Saitama (JP); Daichi KATO, Saitama (JP)

(73) Assignee: Honda Motor Co.,Ltd., Tokyo (JP)

(21) Appl. No.: 15/434,057

(22) Filed: Feb. 16, 2017

(30) Foreign Application Priority Data
Feb. 17, 2016 (JP) 2016-028205

(51) Int. Cl. B60W 30/16; B60W 10/18; B60W 10/04; G05D 1/00

(52) U.S. Cl. CPC B60W 30/16; G05D 1/0088; B60W 10/18; B60W 10/04; B60W 2750/302; B62D 15/0255

(57) ABSTRACT

Provided are a vehicle control device, a vehicle control method, and a vehicle control program for more accurately controlling the velocity of an own vehicle with reference to a preceding vehicle. The vehicle control device includes: an identifying part identifying the velocity of the preceding vehicle present in front of the own vehicle and an inter-vehicle distance between the preceding vehicle and the own vehicle; a deriving part deriving an adjustment value, which is a value associated with the inter-vehicle distance between the preceding vehicle and the own vehicle and decreases as the inter-vehicle distance identified by the identifying part decreases, and deriving a target velocity of the own vehicle based on the derived adjustment value and the velocity of the preceding vehicle identified by the identifying part; and a travel controlling part controlling travel of the own vehicle based on the target velocity derived by the deriving part.

### CROSS-REFERENCE TO RELATED APPLICATION

This application claims the priority benefit of Japan application serial no. 2016-028205, filed on Feb. 17, 2016. The entirety of the above-mentioned patent application is hereby incorporated by reference herein and made a part of this specification.

### BACKGROUND OF THE INVENTION

Field of the Invention

The invention relates to a vehicle control device, a vehicle control method, and a vehicle control program.

Description of Related Art

There are conventional techniques for controlling the velocity of the own vehicle on the basis of the distance to the preceding vehicle that travels in front of the own vehicle. Regarding this, a driving support device is known (refer to Patent Literature 1, for example), which includes: an instruction means for instructing the own vehicle to start automatic driving upon the driver's operation, a setting means for setting a destination for the automatic driving, a determination means for determining the mode of the automatic driving based on whether or not the destination is set when the driver operates the instruction means, and a control means for performing vehicle travel control based on the mode of the automatic driving determined by the determination means. If the destination is not set, the determination means sets the mode of the automatic driving to automatic driving, by which the own vehicle travels along the current path, or automatic stop.

### PRIOR ART LITERATURE

### Patent Literature

Patent Literature 1: International Publication No. 2011/158347

### SUMMARY OF THE INVENTION

### Problem to be Solved

According to the conventional techniques, however, the traveling velocity of the own vehicle is calculated solely based on the distance between the own vehicle and the preceding vehicle. For this reason, sometimes the velocity control of the own vehicle with reference to the preceding vehicle may not be performed accurately.

In view of the above, the invention provides a vehicle control device, a vehicle control method, and a vehicle control program capable of more accurately controlling the velocity of the own vehicle with reference to the preceding vehicle.

### Solution to the Problem

According to an embodiment of the invention, a vehicle control device includes: an identifying part that identifies a velocity of a preceding vehicle present in front of an own vehicle and an inter-vehicle distance between the preceding vehicle and the own vehicle; a deriving part that derives an adjustment value, which is a value associated with the inter-vehicle distance between the preceding vehicle and the own vehicle and decreases as the inter-vehicle distance identified by the identifying part decreases, and derives a target velocity of the own vehicle based on the derived adjustment value and the velocity of the preceding vehicle identified by the identifying part; and a travel controlling part that controls travel of the own vehicle based on the target velocity derived by the deriving part.

According to an embodiment of the invention, based on the aforementioned vehicle control device, the deriving part sets a minimum value for the adjustment value and derives the minimum value of the adjustment value to be high as a velocity of the own vehicle increases.

According to an embodiment of the invention, based on the aforementioned vehicle control device, the deriving part derives the adjustment value to be a value less than an upper limit value if the inter-vehicle distance identified by the identifying part is shorter than a predetermined distance, and sets the adjustment value to the upper limit value if the inter-vehicle distance identified by the identifying part is equal to or longer than the predetermined distance.

According to an embodiment of the invention, based on the aforementioned vehicle control device, the deriving part derives the adjustment value to be a value less than the upper limit value if the velocity of the preceding vehicle is lower than the velocity of the own vehicle, and sets the adjustment value to the upper limit value if the velocity of the preceding vehicle is equal to or higher than the velocity of the own vehicle.

According to an embodiment of the invention, based on the aforementioned vehicle control device, the deriving part derives the adjustment value to be a value less than the upper limit value if the velocity of the own vehicle is lower than a preset velocity, and sets the adjustment value to the upper limit value if the velocity of the own vehicle is equal to or higher than the preset velocity.

According to an embodiment of the invention, based on the aforementioned vehicle control device, the deriving part obtains a weighted sum of a plurality of values, comprising the velocity of the preceding vehicle identified by the identifying part and a difference between the inter-vehicle distance between the preceding vehicle and the own vehicle identified by the identifying part and a target distance, and multiplies the weighted sum by the adjustment value to derive the target velocity of the own vehicle.

According to an embodiment of the invention, based on the aforementioned vehicle control device, the deriving part obtains a weighted sum of a plurality of values, comprising the velocity of the preceding vehicle identified by the identifying part and a relative velocity of the preceding vehicle and the own vehicle, and multiplies the weighted sum by the adjustment value to derive the target velocity of the own vehicle.

According to an embodiment of the invention, based on the aforementioned vehicle control device, the deriving part obtains a weighted sum of a plurality of values, comprising the velocity of the preceding vehicle identified by the identifying part, a difference between the inter-vehicle distance between the preceding vehicle and the own vehicle identified by the identifying part and a target distance, and a relative velocity of the preceding vehicle and the own vehicle, and multiplies the weighted sum by the adjustment value to derive the target velocity of the own vehicle.

According to an embodiment of the invention, a vehicle control method is provided for a computer to: identify a velocity of a preceding vehicle present in front of an own vehicle and an inter-vehicle distance between the preceding vehicle and the own vehicle; derive an adjustment value, which is a value associated with the identified inter-vehicle distance and decreases as the inter-vehicle distance decreases; derive a target velocity of the own vehicle based on the derived adjustment value and the identified velocity of the preceding vehicle; and control travel of the own vehicle based on the derived target velocity.

According to an embodiment of the invention, a vehicle control program is provided, which enables a computer to: identify a velocity of a preceding vehicle present in front of an own vehicle and an inter-vehicle distance between the preceding vehicle and the own vehicle; derive an adjustment value, which is a value associated with the identified inter-vehicle distance and decreases as the inter-vehicle distance decreases; derive a target velocity of the own vehicle based on the derived adjustment value and the identified velocity of the preceding vehicle; and control travel of the own vehicle based on the derived target velocity.

### Effects of the Invention

According to the embodiments of the invention, the adjustment value, which is a value associated with the inter-vehicle distance between the preceding vehicle and the own vehicle and decreases as the inter-vehicle distance decreases, is derived and the target velocity of the own vehicle is derived based on the derived adjustment value and the velocity of the preceding vehicle, so as to more accurately control the velocity of the own vehicle with reference to the preceding vehicle.

According to the embodiment of the invention, the deriving part sets the minimum value for the adjustment value and derives the minimum value of the adjustment value to be high as the velocity of the own vehicle increases, so as to suppress sudden deceleration of the own vehicle when the velocity of the own vehicle is high. Moreover, the deriving part can suppress unnecessary deceleration of the own vehicle.

According to the embodiment of the invention, the deriving part sets the adjustment value to the upper limit value if the inter-vehicle distance is equal to or longer than the predetermined distance, so as to suppress unnecessary deceleration of the own vehicle when the inter-vehicle distance is sufficient.

According to the embodiment of the invention, the deriving part sets the adjustment value to the upper limit value if the velocity of the preceding vehicle is equal to or higher than the velocity of the own vehicle, so as to suppress unnecessary deceleration of the own vehicle.

According to the embodiment of the invention, the deriving part sets the adjustment value to the upper limit value if the velocity of the own vehicle is equal to or higher than the preset velocity. In this case, it is presumed that the inter-vehicle distance between the own vehicle and the preceding vehicle is sufficient. Therefore, the deriving part can suppress unnecessary deceleration of the own vehicle.

According to the embodiment of the invention, the deriving part obtains the weighted sum of a plurality of values, including the velocity of the preceding vehicle and the difference between the inter-vehicle distance between the preceding vehicle and the own vehicle and the target distance, and multiplies the adjustment value by the weighted sum to derive the target velocity of the own vehicle, so as to derive the target velocity that achieves higher safety.

According to the embodiment of the invention, the deriving part obtains the weighted sum of a plurality of values, including the velocity of the preceding vehicle and the relative velocity of the preceding vehicle and the own vehicle, and multiplies the adjustment value by the weighted sum to derive the target velocity of the own vehicle, so as to derive the target velocity that achieves higher safety.

According to the embodiment of the invention, the deriving part obtains the weighted sum of a plurality of values, including the velocity of the preceding vehicle, the difference between the inter-vehicle distance between the preceding vehicle and the own vehicle identified by the identifying part and the target distance, and the relative velocity of the preceding vehicle and the own vehicle, and multiplies the adjustment value by the weighted sum to derive the target velocity of the own vehicle, so as to derive the target velocity that achieves higher safety.

### BRIEF DESCRIPTION OF THE DRAWINGS

FIG. 1 is a diagram showing components of the vehicle equipped with the vehicle control device 100 according to the first embodiment.

FIG. 2 is a functional configuration diagram of the own vehicle M centered on the vehicle control device 100 according to the first embodiment.

FIG. 3 is a diagram showing how the own vehicle position recognition part 102 recognizes the relative position of the own vehicle M with respect to the traveling lane L1.

FIG. 4 is a diagram showing an example of the action plan that has been generated for a certain section.

FIG. 5 is a diagram showing examples of the trajectory generated by the first trajectory generation part 112.

FIG. 6 is a flowchart showing the flow of processing for calculating the target velocity to be executed by the first trajectory generation part 112.

FIG. 7 is a diagram showing an example of the minimum value setting map 157.

FIG. 8 is a diagram showing another example of the minimum value setting map 157.

FIG. 9 is a diagram showing another example of the minimum value setting map 157.

FIG. 10 is a diagram showing an example of the K_{LS} setting map 158.

FIG. 11 is a diagram showing how the target position setting part 122 sets the target position TA.

FIG. 12 is a diagram showing how the second trajectory generation part 126 generates the trajectory.

FIG. 13 is a functional configuration diagram of the own vehicle M centered on the vehicle control device 100A according to the second embodiment.

### DESCRIPTION OF THE EMBODIMENTS

Embodiments of a vehicle control device, a vehicle control method, and a vehicle control program of the invention are described hereinafter with reference to the figures.

### First Embodiment

[Vehicle Configuration]

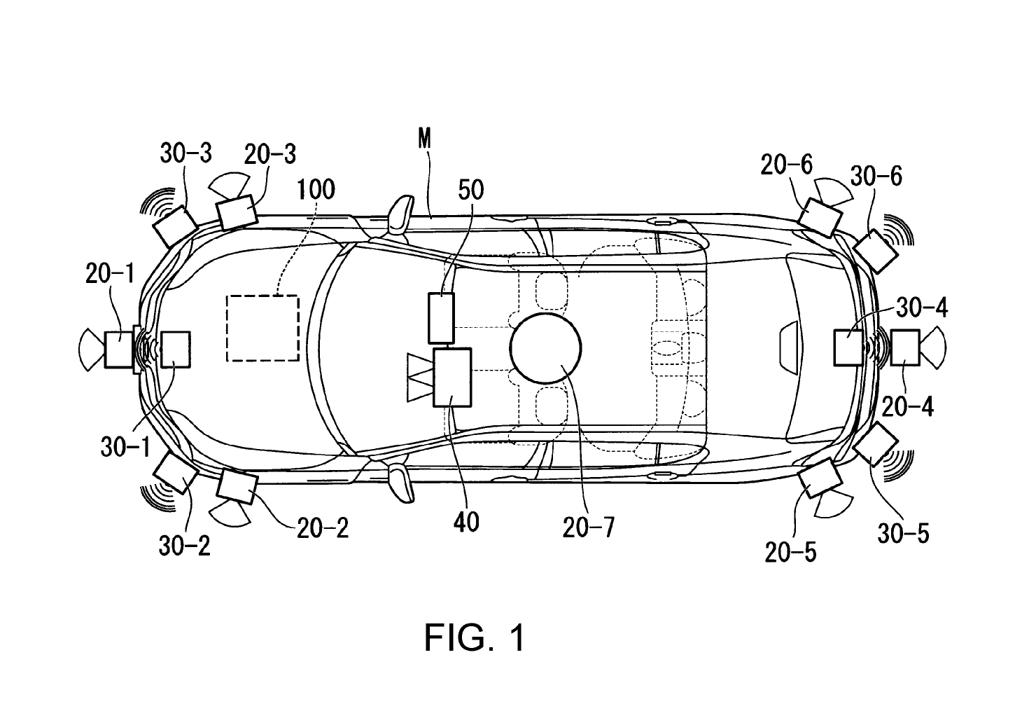

FIG. 1 is a diagram showing components of a vehicle (referred to as an own vehicle M hereinafter) equipped with a vehicle control device 100 according to the first embodiment. The vehicle equipped with the vehicle control device 100 is a two-wheeled automobile, a three-wheeled automobile, a four-wheeled automobile, or the like, for example, and includes an automobile powered by an internal combustion engine such as a diesel engine or a gasoline engine, an electric automobile powered by an electric motor, a hybrid automobile with both an internal combustion engine and an electric motor, etc. In addition, the aforementioned electric automobile is driven by using electric power discharged by batteries, such as a secondary battery, a hydrogen fuel cell, a metal fuel cell, an alcohol fuel cell, and so on.

As shown in FIG. 1, the own vehicle M is equipped with sensors, a navigation device 50, and the aforementioned vehicle control device 100. The sensors include finders 20-1 to 20-7, radars 30-1 to 30-6, a camera 40, etc. The finders 20-1 to 20-7 are, for example, LIDAR (Light Detection and Ranging, or Laser Imaging Detection and Ranging) which measures a scattered light with respect to an irradiation light and measures a distance to an object. For example, the finder 20-1 is attached to a front grille or the like, and the finders 20-2 and 20-3 are respectively attached to a side surface of a vehicle body or a door mirror, inside a headlight, or near a side light. The finder 20-4 is attached to a trunk lid or the like, and the finders 20-5 and 20-6 are attached to the side surface of the vehicle body or inside a taillight. The finders 20-1 to 20-6 described above respectively have a detection area of about 150 degrees with respect to a horizontal direction, for example. Moreover, the finder 20-7 is attached to a roof or the like. The finder 20-7 has a detection area of 360 degrees with respect to the horizontal direction, for example.

The aforementioned radars 30-1 and 30-4 are long-range millimeter wave radars that have a wider detection area in a depth direction than the other radars, for example. In addition, the radars 30-2, 30-3, 30-5, and 30-6 are medium-range millimeter wave radars that have a narrower detection area in the depth direction than the radars 30-1 and 30-4. In the following description, the finders 20-1 to 20-7 are simply referred to as “the finder(s) 20” when they are not particularly distinguished from one another, and the radars 30-1 to 30-6 are simply referred to as “the radar(s) 30” when they are not particularly distinguished from one another. The radar 30 detects an object by means of an FM-CW (Frequency Modulated Continuous Wave), for example.

The camera 40 is a digital camera using a solid state imaging element, such as a CCD (Charge Coupled Device) or a CMOS (Complementary Metal Oxide Semiconductor), for example. The camera 40 is attached to an upper portion of a front windshield, a rear surface of a room mirror, or the like. The camera 40 captures images of the front of the own vehicle M periodically and repeatedly, for example.

Nevertheless, it should be noted that the configuration shown in FIG. 1 is merely an example, and a part of the configuration may be omitted or other configurations may be added thereto.

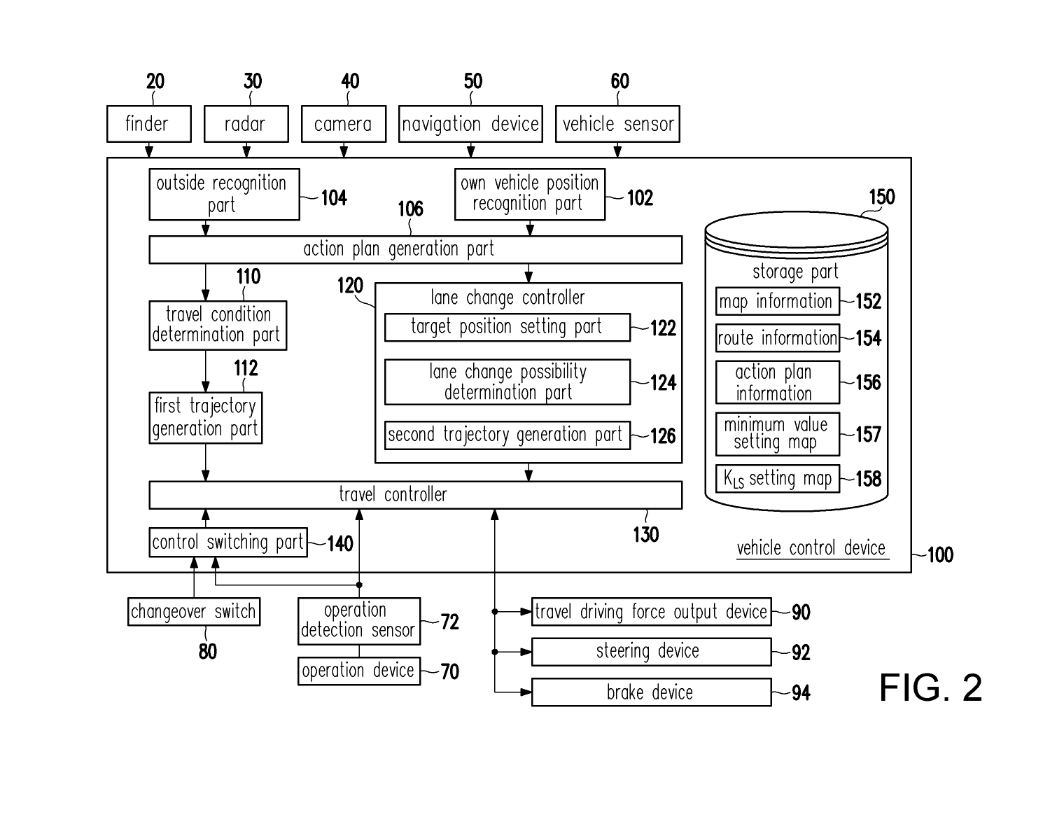

FIG. 2 is a functional configuration diagram of the own vehicle M centered on the vehicle control device 100 according to the first embodiment. In addition to the finders 20, the radars 30, and the camera 40, the navigation device 50, a vehicle sensor 60, an operation device 70, an operation detection sensor 72, a changeover switch 80, a travel driving force output device 90, a steering device 92, a brake device 94, and the vehicle control device 100 are disposed on the own vehicle M. These devices or machines are connected to one another by a multiplex communication line, such as a CAN (Controller Area Network) communication line, or a serial communication line, a wireless communication network or the like.

The navigation device 50 includes a GNSS (Global Navigation Satellite System) receiver or map information (navigation map), a touch panel type display that functions as a user interface, a speaker, a microphone, etc. The navigation device 50 identifies a position of the own vehicle M by the GNSS receiver and derives a route from the position to a destination specified by a user. The route derived by the navigation device 50 is stored in a storage part 150 as route information 154. The position of the own vehicle M may be identified or supplemented by an INS (Inertial Navigation System) that utilizes an output of the vehicle sensor 60. Moreover, when the vehicle control device 100 executes a manual driving mode, the navigation device 50 provides guidance on the route to the destination by voice or navigation display. The configuration for identifying the position of the own vehicle M may also be provided independent of the navigation device 50. Furthermore, the navigation device 50 may be realized by a function of a terminal device, such as a smartphone or a tablet terminal possessed by the user, for example. In that case, information is transmitted and received between the terminal device and the vehicle control device 100 by wireless or wired communication.

The vehicle sensor 60 includes a vehicle velocity sensor for detecting a vehicle velocity, an acceleration sensor for detecting an acceleration, a yaw rate sensor for detecting an angular velocity around a vertical axis, a direction sensor for detecting a direction of the own vehicle M, etc.

The operation device 70 includes an accelerator pedal, a steering wheel, a brake pedal, a shift lever, etc., for example. The operation detection sensor 72, for detecting whether a driver performs an operation or an amount of the operation, is attached to the operation device 70. The operation detection sensor 72 includes an accelerator opening degree sensor, a steering torque sensor, a brake sensor, a shift position sensor, etc., for example. The operation detection sensor 72 outputs an accelerator opening degree, a steering torque, a brake actuation amount, a shift position, etc., as detection results to a travel controller 130. Alternatively, the detection results of the operation detection sensor 72 may be directly outputted to the travel driving force output device 90, the steering device 92, or the brake device 94.

The changeover switch 80 is a switch to be operated by the driver or the like. The changeover switch 80 may be a mechanical switch installed on the steering wheel, a garnish (dashboard), or the like, or a GUI (Graphical User Interface) switch provided on a touch panel of the navigation device 50, for example. The changeover switch 80 accepts the operation of the driver, etc., and generates a control mode designation signal for designating a control mode of the travel controller 130 as either an automatic driving mode or the manual driving mode, and then outputs the control mode designation signal to a control switching part 140. The automatic driving mode refers to a driving mode, in which the vehicle travels in a state where the driver performs no operation (or an operation amount is less or an operation frequency is lower than that of the manual driving mode), as described above, and more specifically, refers to a driving mode, in which part or all of the travel driving force output device 90, the steering device 92, and the brake device 94 are controlled based on an action plan.

For example, the travel driving force output device 90 includes an engine and an engine ECU (Electronic Control Unit) for controlling the engine if the own vehicle M is an automobile powered by an internal combustion engine; the travel driving force output device 90 includes a traveling motor and a motor ECU for controlling the traveling motor if the own vehicle M is an electric automobile powered by an electric motor; and the travel driving force output device 90 includes the engine, the engine ECU, the traveling motor, and the motor ECU if the own vehicle M is a hybrid automobile. If the travel driving force output device 90 includes only the engine, the engine ECU adjusts a throttle opening degree of the engine, a shift stage, etc. according to information inputted from the travel controller 130 (will be described later) and outputs a travel driving force (torque) for the vehicle to travel. Moreover, if the travel driving force output device 90 includes only the traveling motor, the motor ECU adjusts a duty ratio of a PWM signal to be supplied to the traveling motor according to the information inputted from the travel controller 130 and outputs the aforementioned travel driving force. In addition, if the travel driving force output device 90 includes the engine and the traveling motor, the engine ECU and the motor ECU both control the travel driving force in coordination with each other according to the information inputted from the travel controller 130.

The steering device 92 includes an electric motor, a steering torque sensor, a steering angle sensor, etc., for example. For instance, the electric motor changes an orientation of the steering wheel by applying a force to a rack and pinion function, etc. The steering torque sensor detects a torsion of a torsion bar when the steering wheel is operated as the steering torque (steering force), for example. The steering angle sensor detects a steering angle (or an actual steering angle), for example. The steering device 92 drives the electric motor and changes the orientation of the steering wheel according to the information inputted from the travel controller 130.

The brake device 94 is an electric servo brake device that includes a brake caliper, a cylinder for transmitting hydraulic pressure to the brake caliper, an electric motor for generating the hydraulic pressure in the cylinder, and a braking controller, for example. The braking controller of the electric servo brake device controls the electric motor according to the information inputted from the travel controller 130, so as to output a brake torque corresponding to a braking operation to each wheel. The electric servo brake device may include a mechanism for transmitting the hydraulic pressure generated by the operation of the brake pedal to the cylinder via a master cylinder as a backup. Nevertheless, the brake device 94 is not necessarily the electric servo brake device as described above and may also be an electronically controlled hydraulic brake device. The electronically controlled hydraulic brake device controls an actuator according to the information inputted from the travel controller 130 and transmits the hydraulic pressure of the master cylinder to the cylinder. Also, the brake device 94 may include a regenerative brake by the traveling motor, which may be included in the travel driving force output device 90.

[Vehicle Control Device]

The vehicle control device 100 is described hereinafter. The vehicle control device 100 includes an own vehicle position recognition part 102, an outside recognition part 104, an action plan generation part 106, a travel condition determination part 110, a first trajectory generation part 112, a lane change controller 120, the travel controller 130, the control switching part 140, and the storage part 150, for example. Part or all of the own vehicle position recognition part 102, the outside recognition part 104, the action plan generation part 106, the travel condition determination part 110, the first trajectory generation part 112, the lane change controller 120, the travel controller 130, and the control switching part 140 are software functional parts that function through execution of a program performed by a processor, such as a CPU (Central Processing Unit). In addition, part or all of these may be hardware functional parts, such as LSI (Large Scale Integration) and ASIC (Application Specific Integrated Circuit). Moreover, the storage part 150 is realized by a ROM (Read Only Memory), a RAM (Random Access Memory), a HDD (Hard Disk Drive), a flash memory, or the like. The program executed by the processor may be stored in advance in the storage part 150 or may be downloaded from an external device via in-vehicle Internet equipment or the like. The program may also be installed in the storage part 150 by installing a portable storage medium that stores the program in a drive device (not shown).

The own vehicle position recognition part 102 recognizes a lane that the own vehicle M travels (traveling lane) and a relative position of the own vehicle M with respect to the traveling lane based on map information 152 stored in the storage part 150 and information inputted from the finders 20, the radars 30, the camera 40, the navigation device 50, or the vehicle sensor 60. The map information 152 is more accurate than the navigation map of the navigation device 50 and includes information on the center of the lane or information on the boundaries of the lane, for example. More specifically, the map information 152 includes road information, traffic regulation information, address information (address/zip code), facility information, telephone number information, and so forth. The road information includes information indicating the road types such as expressway, toll road, national highway, and prefectural road, and information about the number of lanes on the road, the width of each lane, the gradient of the road, the position of the road (three-dimensional coordinates including longitude, latitude, and height), the curvature of the curve of the lane, the positions of the junction and branch point of the lanes, the signs on the road, etc. Traffic regulation information includes information, such as lanes that are being blocked due to construction, traffic accident, traffic congestion, etc.

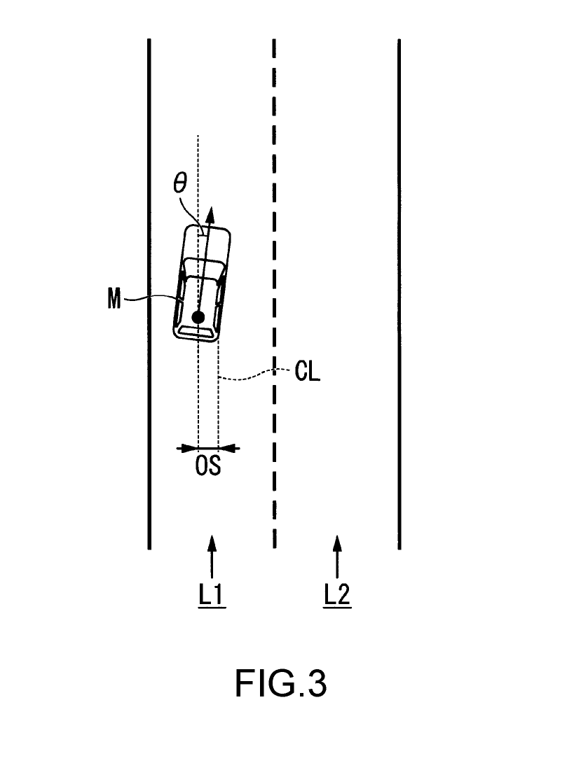

FIG. 3 is a diagram showing how the own vehicle position recognition part 102 recognizes the relative position of the own vehicle M with respect to a traveling lane L1. For example, the own vehicle position recognition part 102 recognizes a deviation OS of a reference point (e.g., the center of gravity) of the own vehicle M from a traveling lane center CL and an angle θ between the traveling direction of the own vehicle M and a line connecting the traveling lane center CL as the relative position of the own vehicle M with respect to the traveling lane L1. Alternatively, the own vehicle position recognition part 102 may recognize the position of the reference point of the own vehicle M with respect to any side end of the traveling lane L1 as the relative position of the own vehicle M with respect to the traveling lane.

The outside recognition part 104 recognizes states (e.g., position, velocity, and acceleration) of the surrounding vehicles based on the information inputted from the finders 20, the radars 30, the camera 40, etc. In this embodiment, the surrounding vehicles refer to vehicles that travel by the own vehicle M and vehicles that travel in the same direction as the own vehicle M. The positions of the surrounding vehicles may be denoted by representative points of the center of gravity or corners of other vehicles or may be denoted by regions that are indicated by the outlines of other vehicles. The “state” of the surrounding vehicle may include whether the surrounding vehicle is accelerating or changing the lane (or whether the surrounding vehicle is about to change the lane) based on the information from the various devices mentioned above. In addition to the surrounding vehicles, the outside recognition part 104 may recognize the positions of guardrails, utility poles, parked vehicles, pedestrians, and other objects.

The action plan generation part 106 generates an action plan in a predetermined section. The predetermined section refers to a section that passes through a toll road, such as expressway, in the route derived by the navigation device 50, for example. Nevertheless, the invention is not limited thereto, and the action plan generation part 106 may generate the action plan for any section.

The action plan is composed of a plurality of events that are to be executed sequentially, for example. The events for example include a deceleration event for decelerating the own vehicle M, an acceleration event for accelerating the own vehicle M, a lane keeping event for enabling the own vehicle M to travel without deviating from the traveling lane, a lane change event for changing the traveling lane, an overtaking event for enabling the own vehicle M to overtake the preceding vehicle, a branch event for the own vehicle M to change to a desired lane at the branch point or to travel without deviating from the current traveling lane, a merging event for enabling the own vehicle M to accelerate/decelerate and change the traveling lane at a merging lane so as to join the main lane, etc. For example, when there is a junction (branch point) on a toll road (e.g., expressway), the vehicle control device 100, in the automatic driving mode, needs to change the lane or keep the lane so as to drive the own vehicle M in the direction of the destination. Accordingly, when it is determined with reference to the map information 152 that a junction exists on the route, the action plan generation part 106 sets a lane change event for changing the lane to a desired lane, which can drive the own vehicle M in the direction of the destination, between the current position (coordinates) of the own vehicle M and the position (coordinates) of the junction. Information indicating the action plan generated by the action plan generation part 106 is stored in the storage part 150 as action plan information 156.

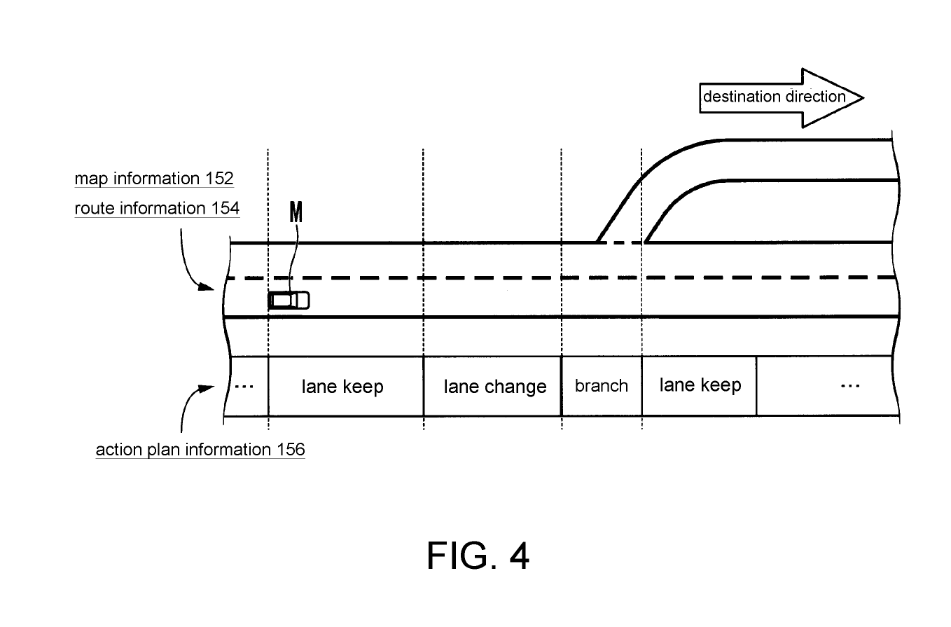

FIG. 4 is a diagram showing an example of the action plan that has been generated for a certain section. As shown in the figure, the action plan generation part 106 classifies occasions that occur when the own vehicle M travels along the route to the destination, and generates the action plan so that the event suitable for each occasion is executed. The action plan generation part 106 may dynamically modify the action plan in accordance with change of a condition of the own vehicle M.

For example, the action plan generation part 106 may modify (update) the generated action plan based on an outside state recognized by the outside recognition part 104. Generally, the outside state changes constantly as the vehicle travels. In particular, when the own vehicle M travels on a road that includes a plurality of lanes, the distances to other vehicles change relatively. For example, if the vehicle in front is decelerated by sudden braking or if the vehicle traveling in the next lane cuts in front of the own vehicle M, the own vehicle M is required to appropriately change the velocity or lane according to the behavior of the vehicle in front or the behavior of the vehicle in the next lane while traveling. Therefore, the action plan generation part 106 may modify the event set for each control section according to the change of the outside state, as described above.

Specifically, when the velocity of another vehicle recognized by the outside recognition part 104 exceeds a threshold value or another vehicle traveling in the lane adjacent to an own lane moves in a direction toward the direction of the own lane during vehicle traveling, the action plan generation part 106 modifies the event that has been set for the driving section where the own vehicle M is scheduled to travel. For example, in the case where the events are set so that the lane change event is executed after the lane keeping event, if the recognition result of the outside recognition part 104 indicates that a vehicle approaches from behind at a velocity over the threshold value in the destination lane of the lane change during the lane keeping event, the action plan generation part 106 changes the event following the lane keeping event from the lane change event to the deceleration event or the lane keeping event. As a result, the vehicle control device 100 can enable the own vehicle M to automatically travel safely even when the outside state changes.

[Lane Keeping Event]

When the lane keeping event included in the action plan is executed by the travel controller 130, the travel condition determination part 110 determines one of constant velocity travel, following travel, deceleration travel, curve travel, obstacle avoiding travel, and so forth as the travel condition. For example, when there is no other vehicle in front of the own vehicle M, the travel condition determination part 110 determines the travel condition to be constant velocity travel. Moreover, when the own vehicle M is to follow the preceding vehicle, the travel condition determination part 110 determines the travel condition to be following travel. In addition, when deceleration of the preceding vehicle by recognized by the outside recognition part 104 or when an event such as stopping or parking is executed, the travel condition determination part 110 determines the travel condition to be deceleration travel. Furthermore, when the outside recognition part 104 recognizes that the own vehicle M has come to a curved road, the travel condition determination part 110 determines the travel condition to be curve travel. In addition, when an obstacle in front of the own vehicle M is recognized by the outside recognition part 104, the travel condition determination part 110 determines the travel condition to be obstacle avoiding travel.

The first trajectory generation part 112 generates a trajectory based on the travel condition determined by the travel condition determination part 110. The trajectory refers to a set of points (locus) obtained by sampling, at predetermined time intervals, future target positions that are assumed to be reached by the own vehicle M when the own vehicle M travels based on the travel condition determined by the travel condition determination part 110. The first trajectory generation part 112 at least calculates (derives) a target velocity based on the velocity of the preceding vehicle in front of the own vehicle M recognized by the own vehicle position recognition part 102 or the outside recognition part 104 and an adjustment value (will be described later). The first trajectory generation part 112 generates a trajectory based on the calculated target velocity. A method of calculating the target velocity of the own vehicle M, executed by the first trajectory generation part 112, will be described later.

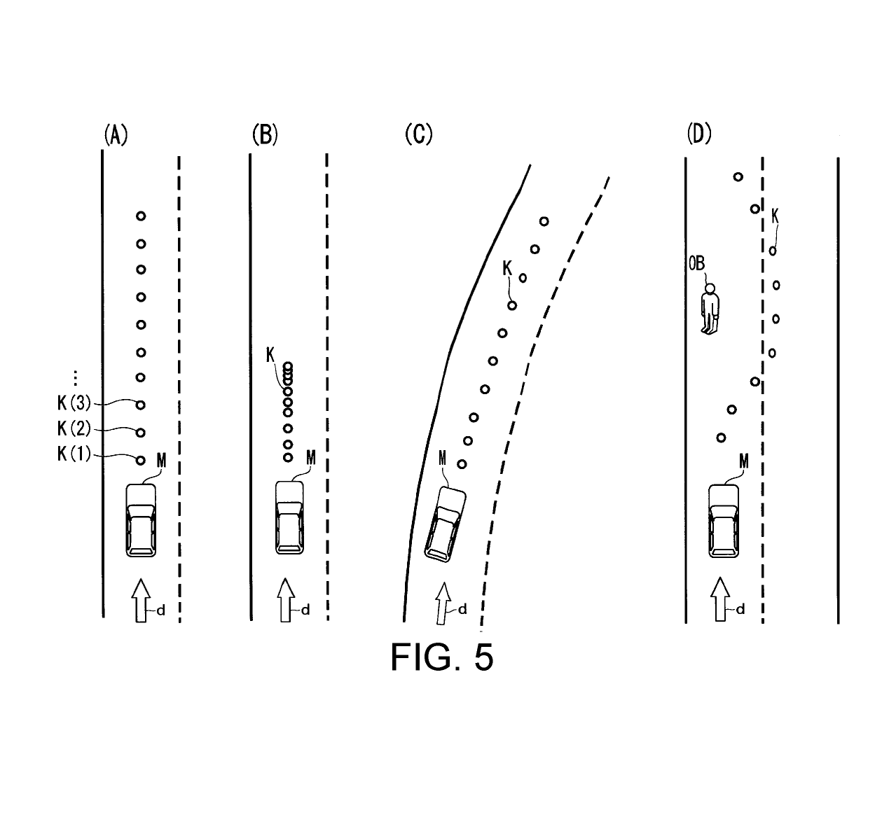

Generation of the trajectory particularly with and without consideration of the presence of an object OB will be described hereinafter. FIG. 5 is a diagram showing examples of the trajectory generated by the first trajectory generation part 112. As shown in FIG. 5(A), for example, the first trajectory generation part 112 sets future target positions K(1), K(2), K(3), . . . as the trajectory of the own vehicle M whenever a predetermined time Δt elapses from the present time, based on the current position of the own vehicle M. Below, these target positions are simply referred to as “the target positions K” when they are not distinguished from one another. The number of the target positions K is determined according to a target time T, for example. For example, when the target time T is set to 5 seconds, the first trajectory generation part 112 sets the target positions K on a center line of the traveling lane in units of the predetermined time Δt (e.g., 0.1 second) in the 5 seconds, and determines an arrangement interval of these target positions K based on the travel condition. The first trajectory generation part 112 may for example derive the center line of the traveling lane from information, such as the width of the lane included in the map information 152, or may obtain the center line of the traveling lane from the map information 152 if it is included in the map information 152 in advance.

For example, when the travel condition determination part 110 determines the travel condition to be constant velocity travel as described above, the first trajectory generation part 112 generates the trajectory by setting multiple target positions K at equal intervals, as shown in FIG. 5(A).

Moreover, when the travel condition determination part 110 determines the travel condition to be deceleration travel (also including a case where the preceding vehicle decelerates during following travel), the first trajectory generation part 112 generates the trajectory by widening the interval between the target positions K where the arrival times are earlier and narrowing the interval between the target positions K where the arrival times are later, as shown in FIG. 5(B). In this case, the preceding vehicle may be set as the object OB, or a point (e.g., a junction point, a branch point, or a target point) or an obstacle other than the preceding vehicle may be set as the object OB. Accordingly, the target position K where the own vehicle M would arrive at a later time is set close to the current position of the own vehicle M, and thus the travel controller 130 (will be described later) decelerates the own vehicle M.

Further, as shown in FIG. 5(C), when the road is a curved road, the travel condition determination part 110 determines the travel condition to be curve travel. In this case, the first trajectory generation part 112 for example arranges the multiple target positions K while changing a lateral position (the position in the lane width direction) with respect to the traveling direction of the own vehicle M according to the curvature of the road, so as to generate the trajectory. In addition, as shown in FIG. 5(D), when an obstacle OB (e.g., a human being or a stopped vehicle) is present on the road ahead of the own vehicle M, the travel condition determination part 110 determines the travel condition to be obstacle avoiding travel. In this case, the first trajectory generation part 112 generates the trajectory by arranging the multiple target positions K to avoid the obstacle OB.

[Following Travel]

A calculation method of a target velocity (Vego_car_target) at the time of following travel or deceleration following the deceleration of the preceding vehicle is described hereinafter. The first trajectory generation part 112 calculates the target velocity by the equation (1), for example. In the equation, K_{LS} is the adjustment value (details will be described later); Vpre_car is the velocity of the preceding vehicle; K1 is a gain; dP is a difference between the distance from the own vehicle M to the preceding vehicle and a target distance, calculated based on the equation (2) (will be described later); K2 is a gain; and dV is a difference between the velocity of the preceding vehicle and the velocity of the own vehicle M, calculated based on the equation (4) (will be described later). Nevertheless, the first trajectory generation part 112 may calculate the target velocity by omitting “K1*dP” and/or “K2*dV” in the equation (1).

Vego_car_target=K_{LS}(Vpre_car+K1*dP+K2*dV) (1)

The first trajectory generation part 112 calculates the difference dP based on the equation (2), for example. In the equation, Dpre_car is the distance from the own vehicle M to the preceding vehicle. In the equation, Dtarget is the preset target distance between the own vehicle M and the preceding vehicle.

dP=Dpre_car−Dtarget (2)

In addition, the first trajectory generation part 112 calculates the target distance Dtarget based on the equation (3), for example. In the equation, Thw is a set time. The set time Thw is a time that is preset arbitrarily (about 1.5 seconds or 2 seconds, for example). The arbitrarily preset time is a time for maintaining a state where the vehicle behind the preceding vehicle can ensure safety without interfering with the preceding vehicle when the preceding vehicle decelerates or stops suddenly. In the equation, Vego_car_act is the velocity of the own vehicle M.

Dtarget=Vego_car_act*Thw (3)

However, the target distance Dtarget may be set not to be equal to or shorter than a minimum target distance min_Dtarget. The minimum target distance min_Dtarget is the minimum target distance between the own vehicle M and the preceding vehicle. The minimum target distance is preset.

The first trajectory generation part 112 may calculate the target distance Dtarget as “Vpre_car*Thw” to replace “Vego_car_act*Thw” in the above equation (3).

The first trajectory generation part 112 calculates the relative velocity dV based on the equation (4), for example.

dV=Vpre_car−Vego_car_act (4)

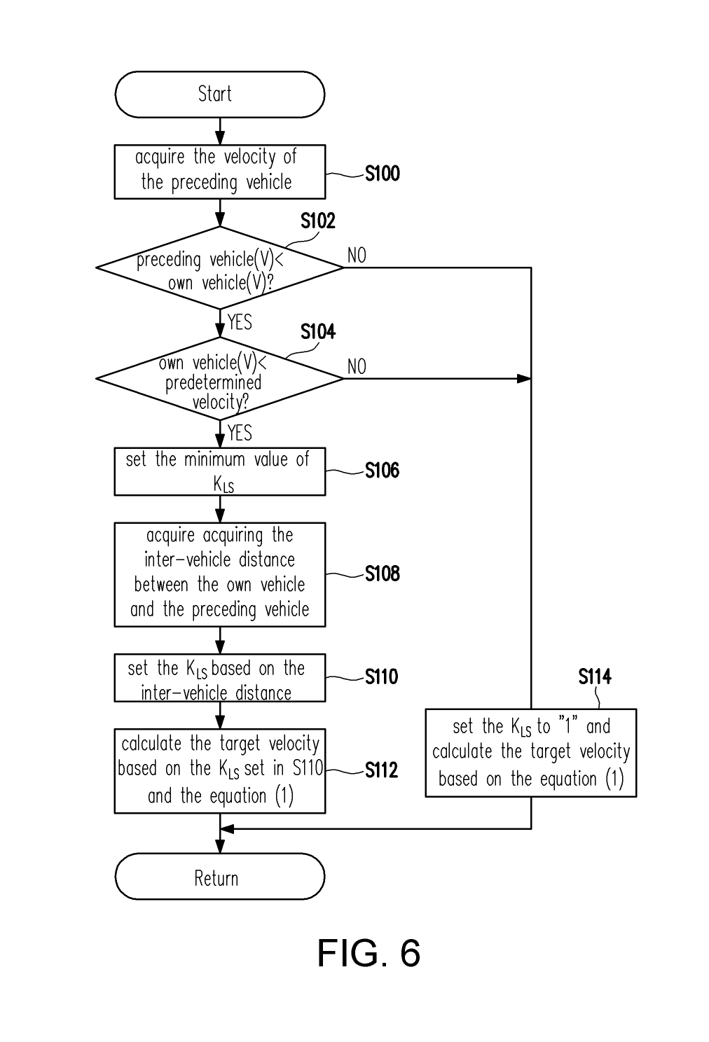

FIG. 6 is a flowchart showing the flow of processing for calculating the target velocity to be executed by the first trajectory generation part 112. The processing of this flowchart is repeatedly executed at a predetermined interval, for example.

First, the first trajectory generation part 112 acquires the velocity of the preceding vehicle based on the recognition result of the outside recognition part 104 (Step S100). The preceding vehicle includes a vehicle that travels right before the own vehicle M or a vehicle that stops in front of the own vehicle M. Then, the first trajectory generation part 112 determines whether the velocity (V) of the preceding vehicle is lower than the velocity (V) of the own vehicle M based on the detection result of the vehicle sensor 60 and the vehicle velocity of the preceding vehicle acquired in Step S100 (Step S102). If the velocity (V) of the preceding vehicle is equal to or higher than the velocity (V) of the own vehicle M, the processing proceeds to Step S114.

If the velocity (V) of the preceding vehicle is lower than the velocity (V) of the own vehicle M, the first trajectory generation part 112 determines whether the velocity of the own vehicle M is lower than a predetermined velocity (e.g., 50 [km/h]) (Step S104). If the velocity of the own vehicle M is equal to or higher than the predetermined velocity, the processing proceeds to Step S114.

If the velocity of the own vehicle M is lower than the predetermined velocity, the first trajectory generation part 112 sets the minimum value of the adjustment value K_{LS} (Step S106). The first trajectory generation part 112 sets the minimum value of the adjustment value K_{LS} based on a minimum value setting map 157, in which the minimum value of the adjustment value K_{LS} and the velocity of the own vehicle M are associated with each other, for example. The minimum value setting map 157 is stored in the storage part 150.

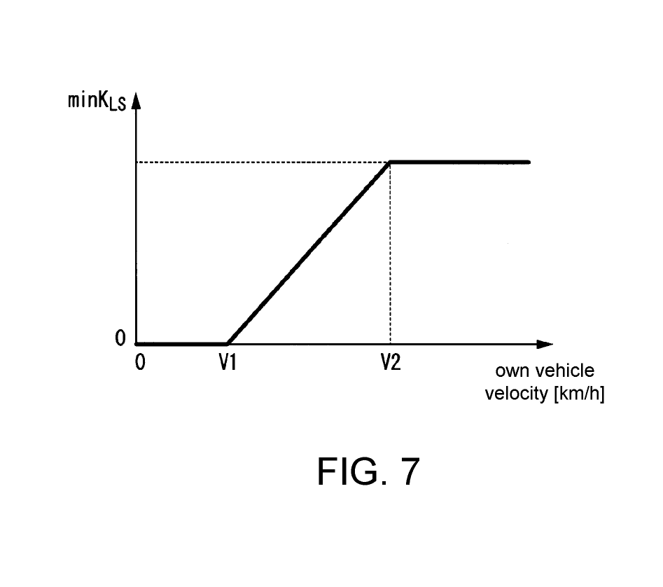

FIG. 7 is a diagram showing an example of the minimum value setting map 157. In the minimum value setting map 157, the minimum value minK_{LS} of the adjustment value K_{LS} is stored so as to increase as the velocity of the own vehicle M increases. The first trajectory generation part 112 sets the minimum value of the adjustment value K_{LS} to a value close to 0 (e.g., 0) if the velocity of the own vehicle M is equal to or lower than V1 (e.g., 25 [km/h]). Further, if the velocity of the own vehicle M is equal to or higher than V2, which is higher than V1, the first trajectory generation part 112 sets the minimum value of the adjustment value K_{LS} to an upper limit value close to 1 (e.g., 0.8). The first trajectory generation part 112 sets the minimum value of the adjustment value K_{LS} higher as the velocity of the own vehicle M increases in the range between V1 and V2.

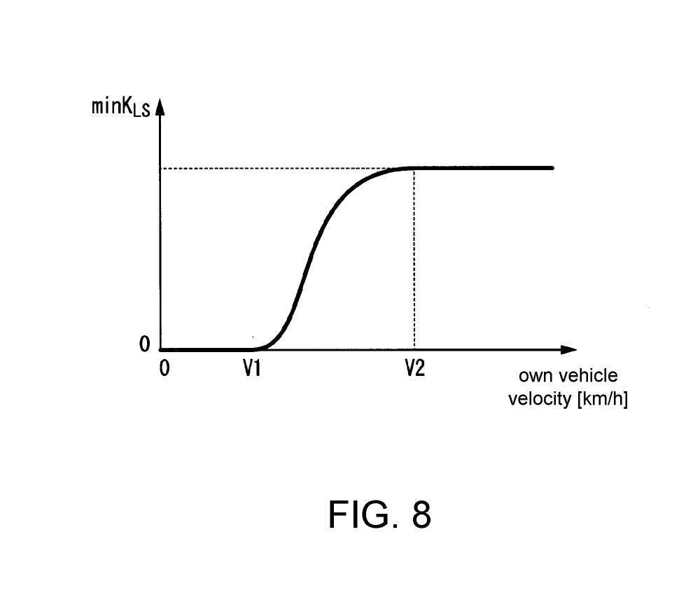

In FIG. 7, the minimum value minK_{LS} increases linearly between the minimum value and the maximum value of the minimum value minK_{LS}. However, the vehicle control device 100 may use a map that the minimum value minK_{LS} increases in a curved or stepwise manner. FIG. 8 is a diagram showing another example of the minimum value setting map 157. By using the minimum value setting map in which the minimum value minK_{LS} increases in a curved manner, the first trajectory generation part 112 can set the minimum value minK_{LS} according to the own vehicle velocity more appropriately.

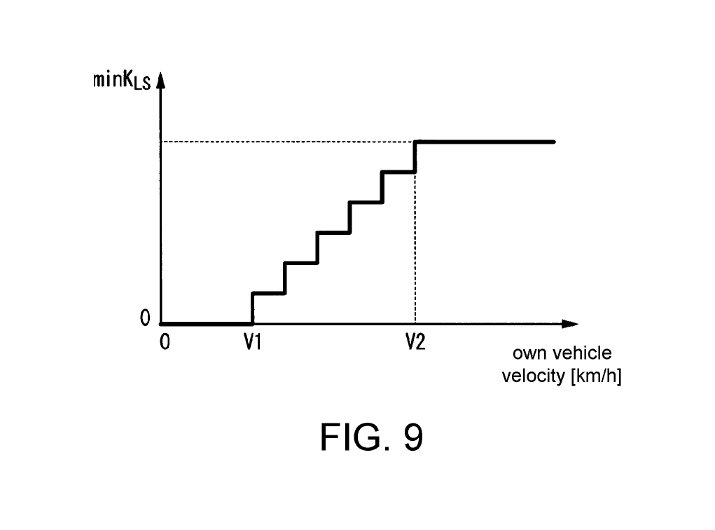

FIG. 9 is a diagram showing another example of the minimum value setting map 157. By setting the minimum value minK_{LS} of the minimum value setting map in a stepwise manner, the minimum value setting map can be configured easily. Nevertheless, the first trajectory generation part 112 may also derive the minimum value minK_{LS} of the adjustment value K_{LS} by using a preset function, instead of the minimum value setting map.

Next, the first trajectory generation part 112 acquires an inter-vehicle distance between the own vehicle M and the preceding vehicle based on the recognition result of the outside recognition part 104 (Step S108). Thereafter, the first trajectory generation part 112 sets the adjustment value K_{LS} based on the inter-vehicle distance acquired in Step S108 (Step S110). The first trajectory generation part 112 sets the adjustment value K_{LS} based on a K_{LS} setting map 158, in which the adjustment value K_{LS} and the inter-vehicle distance are associated with each other. The K_{LS} setting map 158 is stored in the storage part 150.

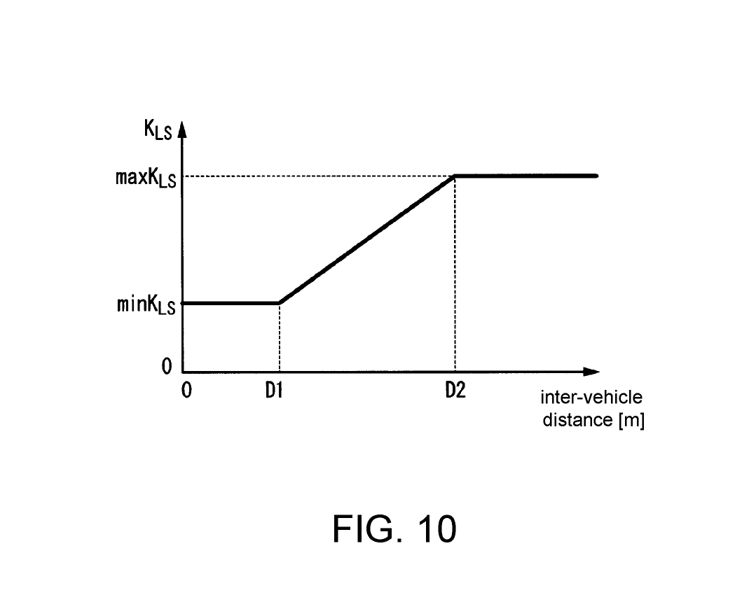

FIG. 10 is a diagram showing an example of the K_{LS} setting map 158. In the K_{LS} setting map 158, the value of the adjustment value K_{LS} is stored so as to decrease as the inter-vehicle distance between the own vehicle M and the preceding vehicle decreases. If the inter-vehicle distance is equal to or shorter than D1 (e.g., 10 m), the first trajectory generation part 112 sets the value of the adjustment value K_{LS} to the minimum value of the adjustment value K_{LS} set in Step S106. In addition, if the inter-vehicle distance is equal to or longer than D2, which is longer than D1, the first trajectory generation part 112 sets the adjustment value K_{LS} to the upper limit value maxK_{LS}. The upper limit value maxK_{LS} is “1” (or “a value close to 1”), for example. The “D2” is the “target distance Dtarget” (will be described later), for example. The first trajectory generation part 112 sets the value of the adjustment value K_{LS} lower as the inter-vehicle distance decreases in the range between D1 and D2. Like the minimum value setting map of FIG. 8 or FIG. 9, the K_{LS} setting map 158 of FIG. 10 may set the portion where the adjustment value K_{LS} increases linearly corresponding to the inter-vehicle distance (the straight line between the minimum value minK_{LS} and the upper limit value maxK_{LS}) in a curved or stepwise manner. Furthermore, the first trajectory generation part 112 may derive the adjustment value K_{LS} by using a preset function, instead of the adjustment value K_{LS} map.

Next, the first trajectory generation part 112 calculates a target velocity based on the adjustment value K_{LS} set in Step S110 and the equation (1) (Step S112). In Step S114, the first trajectory generation part 112 sets the adjustment value K_{LS} to “1” and calculates the target velocity of the own vehicle M by using the equation (1). Accordingly, the processing of this flowchart ends.

Considered here is a case where the target velocity is calculated without using the adjustment value K_{LS}. For example, the target velocity is calculated by the equation (1) with the adjustment value K_{LS} omitted. In this case, the target velocity may be higher than the ideal velocity due to errors of the sensors, delay in responsiveness of the processing, etc. This phenomenon is apt to occur during low to medium velocity travel, such as traffic congestion.

In contrast thereto, the vehicle control device 100 of this embodiment sets the adjustment value K_{LS} to a smaller value as the inter-vehicle distance between the own vehicle M and the preceding vehicle decreases and multiplies these to calculate the target vehicle velocity, and therefore can perform deceleration with high responsiveness when the inter-vehicle distance is shortened. Consequently, control over the velocity of the own vehicle with reference to the preceding vehicle can be performed more accurately.

Moreover, as shown in FIG. 7 to FIG. 9, the vehicle control device 100 can change the minimum value of the adjustment value K_{LS} according to the velocity of the own vehicle M, so as to prevent the velocity of the own vehicle M from being suddenly suppressed when the velocity of the own vehicle M is in a medium velocity range or a high velocity range (e.g., about 50 [km/h]). As a result, the ride comfort of the occupants can be improved. In addition, the vehicle control device 100 can change the minimum value of the adjustment value K_{LS} according to the velocity of the own vehicle M, so as to suppress unnecessary deceleration. The unnecessary deceleration refers to deceleration when the velocity of the own vehicle M is in the medium velocity range or the high velocity range and the inter-vehicle distance with respect to the preceding vehicle is sufficiently maintained.

Furthermore, as shown in FIG. 7 to FIG. 9 and FIG. 10, the vehicle control device 100 sets the adjustment value K_{LS} to a smaller value (e.g., 0) when the predetermined conditions are satisfied (for example, the own vehicle velocity is lower than V1 and the inter-vehicle distance is equal to or shorter than D1), and therefore can control the own vehicle M to maintain an appropriate inter-vehicle distance with respect to the preceding vehicle.

In this way, the vehicle control device 100 changes the minimum value of the adjustment value K_{LS} according to the velocity of the own vehicle M, sets the adjustment value K_{LS} to a smaller value as the inter-vehicle distance between the own vehicle M and the preceding vehicle decreases, and calculates the adjustment value K_{LS}, which is set to (Vpre_car+K1*dP+K2*dV), by multiplication, so as to calculate the target velocity of the own vehicle M and thereby more accurately control the velocity of the own vehicle with reference to the preceding vehicle.

In addition, the vehicle control device 100 of this embodiment obtains a weighted sum of multiple values that include the difference dP between the inter-vehicle distance between the preceding vehicle and the own vehicle and the target distance, and multiplies the adjustment value K_{LS} by the weighted sum, so as to calculate the target velocity of the own vehicle. Accordingly, even if the preceding vehicle decelerates suddenly, the vehicle control device 100 can quickly decelerate the own vehicle M.

[Lane Change Event]

The lane change controller 120 performs control when a lane change event included in the action plan is executed by the travel controller 130. The lane change controller 120 includes a target position setting part 122, a lane change possibility determination part 124, and a second trajectory generation part 126, for example. The lane change controller 120 may also perform the processing described below when the travel controller 130 executes a branch event or a merging event.

The target position setting part 122 identifies a vehicle that travels before the own vehicle M in an adjacent lane adjacent to the lane (own lane), in which the own vehicle M travels, and a vehicle that travels behind the own vehicle M in the adjacent lane. The target position setting part 122 sets a target position TA between these vehicles. In the following description, the vehicle that travels before the own vehicle M in the adjacent lane is referred to as a front reference vehicle, and the vehicle that travels behind the own vehicle M in the adjacent lane is referred to as a rear reference vehicle. The target position TA is a relative region based on the positional relationship between the own vehicle M and the front reference vehicle and the rear reference vehicle.

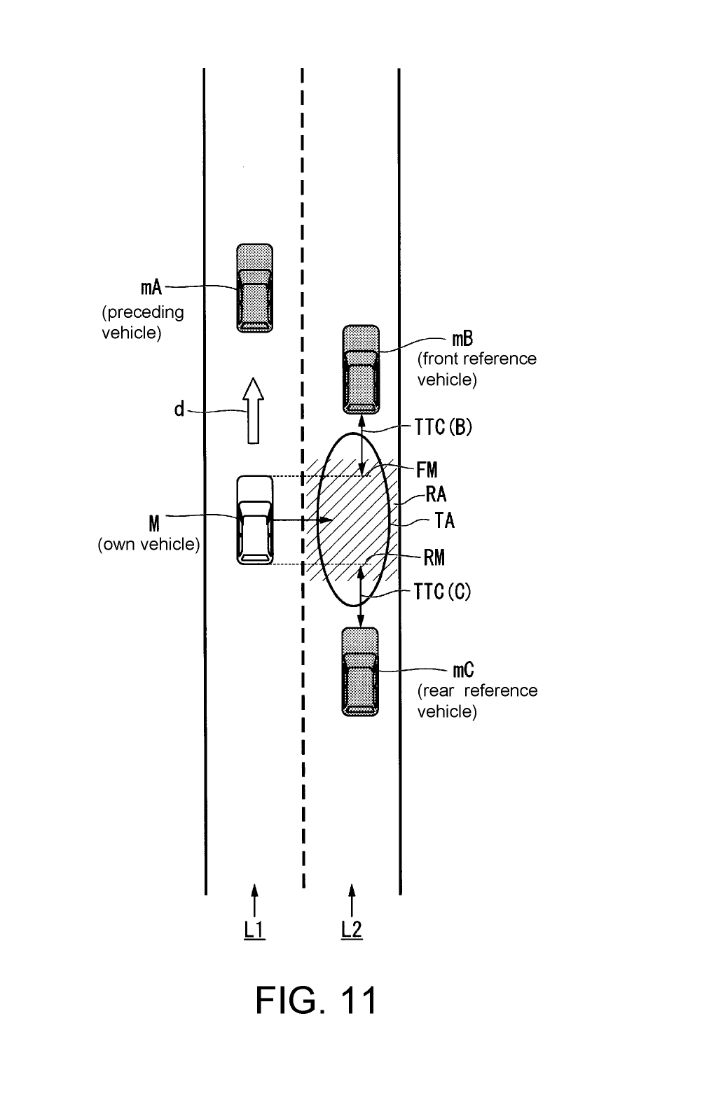

FIG. 11 is a diagram showing how the target position setting part 122 sets the target position TA. In the figure, mA represents the preceding vehicle, mB represents the front reference vehicle, and mC represents the rear reference vehicle. Moreover, the arrow d indicates the traveling (running) direction of the own vehicle M, L1 indicates the own lane, and L2 indicates the adjacent lane.

The lane change possibility determination part 124 determines whether it is possible to change the lane to the target position TA set by the target position setting part 122 (that is, between the front reference vehicle mB and the rear reference vehicle mC).

First, the lane change possibility determination part 124 projects the own vehicle M to the lane change destination lane L2 and sets a prohibition region RA with a slight margin distance in the front and rear, for example. The prohibition region RA is set as a region that extends from one end to the other end of the lane L2 in the lateral direction. If any part of the surrounding vehicles is present in the prohibition region RA, the lane change possibility determination part 124 determines that it is not possible to change the lane to the target position TA.

If no surrounding vehicle is present in the prohibition region RA, the lane change possibility determination part 124 further determines whether it is possible to perform lane change based on a time-to collision TTC between the own vehicle M and the surrounding vehicles. For example, the lane change possibility determination part 124 estimates an extension line FM and an extension line RM by virtually extending the front end and the rear end of the own vehicle M to the side of the lane change destination lane L2. The extension line FM is a line obtained by virtually extending the front end of the own vehicle M, and the extension line RM is a line obtained by virtually extending the rear end of the own vehicle M. The lane change possibility determination part 124 calculates the time-to collision TTC(B) between the extension line FM and the front reference vehicle mB and the time-to collision TTC(C) between the extension line RM and the rear reference vehicle mC. The time-to collision TTC(B) is a time derived by dividing a distance between the extension line FM and the front reference vehicle mB by a relative velocity of the own vehicle M and the front reference vehicle mB. The time-to collision TTC(C) is a time derived by dividing a distance between the extension line RM and the rear reference vehicle mC by a relative velocity of the own vehicle M and the rear reference vehicle mC. If the time-to collision TTC(B) is greater than a threshold value Th(B) and the time-to collision TTC(C) is greater than a threshold value Th(C), the lane change possibility determination part 124 determines that it is possible for the own vehicle M to change the lane to the target position TA.

The target position setting part 122 may also set the target position TA behind the rear reference vehicle mC (between the rear reference vehicle mC and a vehicle behind the rear reference vehicle mC) in the adjacent lane L2.

In addition, the lane change possibility determination part 124 may determine whether it is possible for the own vehicle M to change the lane to the target position TA with consideration of the velocities, accelerations, or jerks of the preceding vehicle mA, the front reference vehicle mB, and the rear reference vehicle mC. For example, if the velocities of the front reference vehicle mB and the rear reference vehicle mC are higher than the velocity of the preceding vehicle mA and it is anticipated that the front reference vehicle mB and the rear reference vehicle mC will overtake the preceding vehicle mA within a range of time required for the own vehicle M to change the lane, the lane change possibility determination part 124 determines that it is not possible for the own vehicle M to change the lane into the target position TA set between the front reference vehicle mB and the rear reference vehicle mC.

If the aforementioned lane change possibility determination part 124 determines that it is possible for the own vehicle M to change the lane to the target position TA, the second trajectory generation part 126 generates a trajectory for changing the lane into the target position TA.

For example, the second trajectory generation part 126 calculates the target velocity based on the velocity of the front reference vehicle mB (or the preceding vehicle mA) present in front of the own vehicle M, which is recognized by the own vehicle position recognition part 102 or the outside recognition part 104, and the adjustment value K_{LS}. The second trajectory generation part 126 calculates an upper limit velocity with reference to the preceding vehicle mA by using the aforementioned equation (1), for example. The second trajectory generation part 126 generates the trajectory for lane change based on the calculated target velocity. The second trajectory generation part 126 may obtain the target velocity (the upper limit velocity) by the equation (1) with reference to the front reference vehicle mB of the lane change destination. For example, if the distance between the own vehicle M and the preceding vehicle mA is equal to or longer than a first predetermined distance and the distance between the own vehicle M and the rear reference vehicle mC is equal to or longer than a second predetermined distance (or if any of the above is satisfied), the second trajectory generation part 126 may start velocity control for following the front reference vehicle mB. In this case, if the above condition is satisfied, the second trajectory generation part 126 starts calculating the target velocity based on the equation (1) with reference to the front reference vehicle mB of the lane change destination in the lane L1 where the own vehicle M starts the lane change. Accordingly, the second trajectory generation part 126 enables the own vehicle M to smoothly change the lane to the rear of the front reference vehicle mB in the lane change destination lane L2 while following the front reference vehicle mB of the lane change destination based on the calculated target velocity.

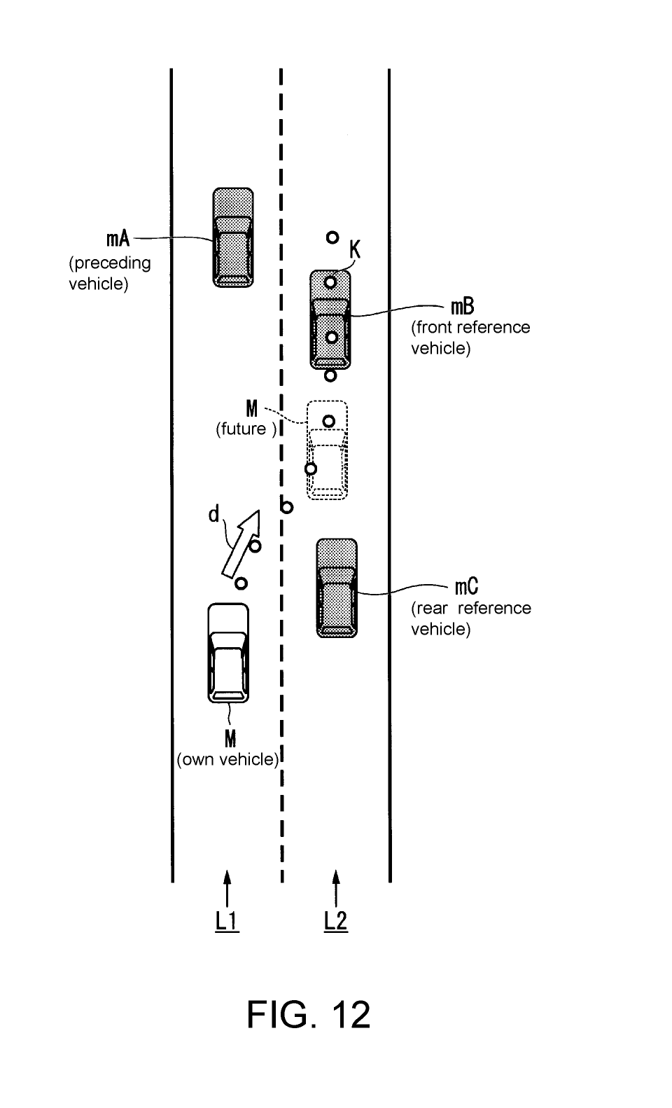

FIG. 12 is a diagram showing how the second trajectory generation part 126 generates the trajectory. For example, the second trajectory generation part 126 assumes that the preceding vehicle mA, the front reference vehicle mB, and the rear reference vehicle mC travel according to predetermined velocity models, and based on the velocity models of the three vehicles and the velocity of the own vehicle M, generates the trajectory such that the own vehicle M is located between the front reference vehicle mB and the rear reference vehicle mC at a certain future time without interfering with the preceding vehicle mA. For example, the second trajectory generation part 126 smoothly connects the current position of the own vehicle M, the center of the lane change destination lane, and the end point of the lane change by using a polynomial curve, such as a spline curve, and arranges a predetermined number of target positions K at equal or unequal intervals on the curve. At this time, the second trajectory generation part 126 generates the trajectory such that at least one of the target positions K falls within the target position TA.

[Travel Control]

The travel controller 130 sets the control mode to the automatic driving mode or the manual driving mode under control of the control switching part 140 and controls controlled objects, including part or all of the travel driving force output device 90, the steering device 92, and the brake device 94, in accordance with the set control mode. In the automatic driving mode, the travel controller 130 reads the action plan information 156 generated by the action plan generation part 106 and controls the controlled objects based on the event included in the read action plan information 156.

For example, if the event is a lane keeping event, the travel controller 130 determines a control amount (e.g., rotation speed) of the electric motor of the steering device 92 and a control amount (e.g., throttle opening degree of the engine, shift stage, etc.) of the ECU of the travel driving force output device 90 in accordance with the trajectory generated by the first trajectory generation part 112. Specifically, the travel controller 130 derives the velocity of the own vehicle M per predetermined time Δt based on the distance between the target positions K on the trajectory and the predetermined time Δt when the target positions K are arranged, and determines the control amount of the ECU of the travel driving force output device 90 according to the velocity per predetermined time Δt. Moreover, the travel controller 130 determines the control amount of the electric motor of the steering device 92 according to the angle formed between the traveling direction of the own vehicle M at each target position K and the direction of the next target position with reference to the aforesaid target position.

Furthermore, if the event is a lane change event, the travel controller 130 determines the control amount of the electric motor of the steering device 92 and the control amount of the ECU of the travel driving force output device 90 according to the trajectory generated by the second trajectory generation part 126.

The travel controller 130 outputs information that indicates the control amounts determined for each event to the corresponding controlled objects. Thereby, the respective devices (90, 92, and 94) serving as the controlled objects are able to control their own devices according to the information indicating the control amounts inputted from the travel controller 130. In addition, the travel controller 130 appropriately adjusts the determined control amounts on the basis of the detection result of the vehicle sensor 60.

Further, in the manual driving mode, the travel controller 130 controls the controlled objects based on the operation detection signal outputted by the operation detection sensor 72. For example, the travel controller 130 outputs the operation detection signal outputted by the operation detection sensor 72 as it is to each device that serves as the controlled object.

Based on the action plan information 156 that is generated by the action plan generation part 106 and stored in the storage part 150, the control switching part 140 switches the control mode of the travel controller 130 of the own vehicle M from the automatic driving mode to the manual driving mode, or from the manual driving mode to the automatic driving mode. Besides, the control switching part 140 switches the control mode of the travel controller 130 of the own vehicle M from the automatic driving mode to the manual driving mode or from the manual driving mode to the automatic driving mode based on the control mode designation signal inputted from the changeover switch 80. That is, the control mode of the travel controller 130 can be changed arbitrarily during travel or stop by the operation of the driver, etc.

Furthermore, the control switching part 140 switches the control mode of the travel controller 130 of the own vehicle M from the automatic driving mode to the manual driving mode based on the operation detection signal inputted from the operation detection sensor 72. For example, if the operation amount included in the operation detection signal exceeds a threshold value, that is, if the operation device 70 receives an operation with an operation amount over the threshold value, the control switching part 140 switches the control mode of the travel controller 130 from the automatic driving mode to the manual driving mode. For example, when the own vehicle M travels automatically with the travel controller 130 set to the automatic driving mode, if the driver operates the steering wheel, the accelerator pedal, or the brake pedal with an operation amount exceeding the threshold value, the control switching part 140 switches the control mode of the travel controller 130 from the automatic driving mode to the manual driving mode. Accordingly, upon the operation that the driver performs instantly when an object, e.g., a human being, rushes out onto the roadway or when the preceding vehicle mA suddenly stops, the vehicle control device 100 can immediately switch to the manual driving mode without operation of the changeover switch 80. As a result, the vehicle control device 100 can respond to the operation performed by the driver in the event of an emergency and thereby improve the safety during traveling.

According to the first embodiment as described above, the vehicle control device 100 calculates the target velocity of the own vehicle M based on the velocity of the preceding vehicle and the adjustment value, which is a value associated with the inter-vehicle distance between the preceding vehicle and the own vehicle and decreases as the inter-vehicle distance decreases, so as to more accurately control the velocity of the own vehicle with reference to the preceding vehicle.

### Second Embodiment

The second embodiment is described hereinafter. The second embodiment is different from the first embodiment in that a vehicle control device 100A does not perform automatic driving by setting an event based on the route to the destination but simply enables the own vehicle M to follow the preceding vehicle that travels in front of the own vehicle M. The following focuses on the difference.

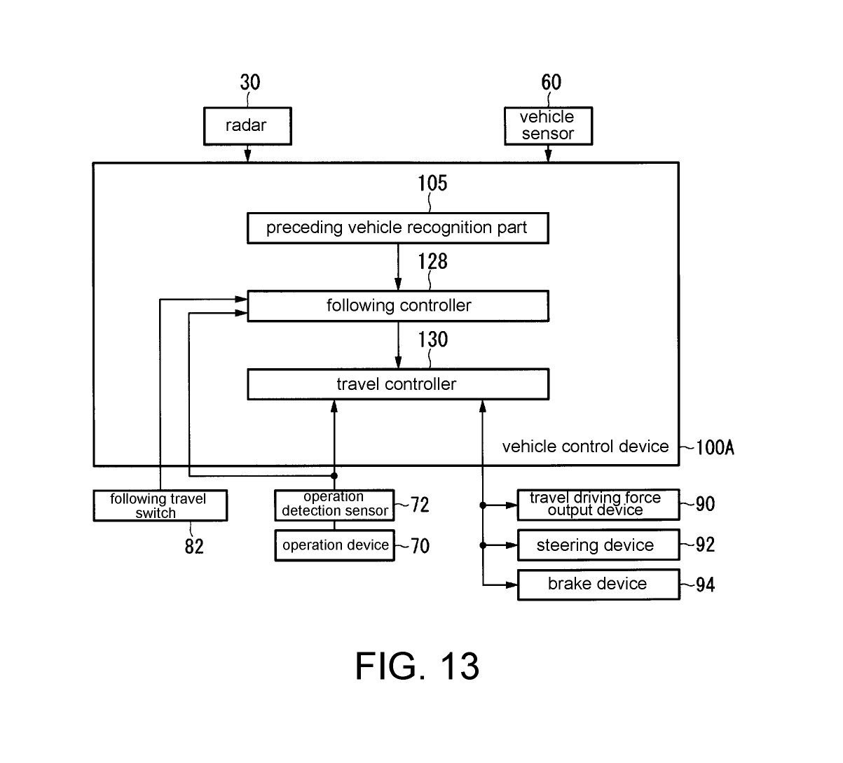

FIG. 13 is a functional configuration diagram of the own vehicle M centered on the vehicle control device 100A according to the second embodiment. The own vehicle M is equipped with the radars 30, the vehicle sensor 60, the operation device 70, the operation detection sensor 72, a following travel switch 82, the travel driving force output device 90, the steering device 92, the brake device 94, and the vehicle control device 100A. The vehicle control device 100A includes a preceding vehicle recognition part 105, a following controller 128, and the travel controller 130. Descriptions of configurations or functional parts that are the same as those of the first embodiment will be omitted hereinafter.

The following travel switch 82 is a switch to be operated by the driver, etc. The following travel switch 82 accepts the operation of the driver, etc., and generates a control mode designation signal for designating the control mode of the travel controller 130 as either a following travel condition or a manual driving mode, and outputs the control mode designation signal to the following controller 128. The following travel condition refers to a mode for the own vehicle M to travel following the preceding vehicle while maintaining a constant inter-vehicle distance to the preceding vehicle when the preceding vehicle is present, or to travel at a preset velocity when no preceding vehicle is present.

The preceding vehicle recognition part 105 recognizes the preceding vehicle detected by the radars 30. The following controller 128 calculates the target velocity of the own vehicle M when the operation of the driver, etc. is received by the following travel switch 82. If no preceding vehicle is present, the following controller 128 calculates a preset target velocity. If the preceding vehicle is present, the following controller 128 calculates the target velocity for maintaining the constant inter-vehicle distance between the preceding vehicle and the own vehicle M to follow the preceding vehicle. The following controller 128 calculates the target velocity in the same way as the first embodiment, based on the equation (1) using the velocity of the preceding vehicle recognized by the preceding vehicle recognition part 105 and the adjustment value K_{LS}. The travel controller 130 acquires the target velocity calculated by the following controller 128 and controls the travel driving force output device 90, the brake device 94, and the operation amount of the accelerator pedal for the own vehicle M to travel at the acquired target velocity. The following controller 128 switches the control mode of the travel controller 130 of the own vehicle M from the following travel condition to the manual driving mode based on the operation detection signal inputted from the operation detection sensor 72.

According to the second embodiment as described above, the vehicle control device 100A calculates the target velocity of the own vehicle M based on the velocity of the preceding vehicle and the adjustment value, which is a value associated with the inter-vehicle distance between the preceding vehicle and the own vehicle and decreases as the inter-vehicle distance decreases, so as to more accurately control the velocity of the own vehicle with reference to the preceding vehicle as in the first embodiment.

Several embodiments for implementing the invention have been described above. However, the invention should not be construed as being limited to these embodiments, and various modifications and substitutions may be made without departing from the scope of the invention.

What is claimed is:

1. A vehicle control device, comprising:
an identifying part that identifies a velocity of a preceding vehicle present in front of an own vehicle and an inter-vehicle distance between the preceding vehicle and the own vehicle;
a deriving part that derives an adjustment value, which is a value associated with the inter-vehicle distance between the preceding vehicle and the own vehicle and decreases as the inter-vehicle distance identified by the identifying part decreases, and derives a target velocity of the own vehicle based on the derived adjustment value and the velocity of the preceding vehicle identified by the identifying part; and
a travel controlling part that controls travel of the own vehicle based on the target velocity derived by the deriving part.

2. The vehicle control device according to claim 1, wherein the deriving part sets a minimum value for the adjustment value and derives the minimum value of the adjustment value to be high as a velocity of the own vehicle increases.

3. The vehicle control device according to claim 1, wherein the deriving part derives the adjustment value to be a value less than an upper limit value if the inter-vehicle distance identified by the identifying part is shorter than a predetermined distance, and sets the adjustment value to the upper limit value if the inter-vehicle distance identified by the identifying part is equal to or longer than the predetermined distance.

4. The vehicle control device according to claim 2, wherein the deriving part derives the adjustment value to be a value less than an upper limit value if the inter-vehicle distance identified by the identifying part is shorter than a predetermined distance, and sets the adjustment value to the upper limit value if the inter-vehicle distance identified by the identifying part is equal to or longer than the predetermined distance.

5. The vehicle control device according to claim 3, wherein the deriving part derives the adjustment value to be a value less than the upper limit value if the velocity of the preceding vehicle is lower than the velocity of the own vehicle, and sets the adjustment value to the upper limit value if the velocity of the preceding vehicle is equal to or higher than the velocity of the own vehicle.

6. The vehicle control device according to claim 4, wherein the deriving part derives the adjustment value to be a value less than the upper limit value if the velocity of the preceding vehicle is lower than the velocity of the own vehicle, and sets the adjustment value to the upper limit value if the velocity of the preceding vehicle is equal to or higher than the velocity of the own vehicle.

7. The vehicle control device according to claim 5, wherein the deriving part derives the adjustment value to be a value less than the upper limit value if the velocity of the own vehicle is lower than a preset velocity, and sets the adjustment value to the upper limit value if the velocity of the own vehicle is equal to or higher than the preset velocity.

8. The vehicle control device according to claim 6, wherein the deriving part derives the adjustment value to be a value less than the upper limit value if the velocity of the own vehicle is lower than a preset velocity, and sets the adjustment value to the upper limit value if the velocity of the own vehicle is equal to or higher than the preset velocity.

9. The vehicle control device according to claim 5, wherein the deriving part obtains a weighted sum of a plurality of values, comprising the velocity of the preceding vehicle identified by the identifying part and a difference between the inter-vehicle distance between the preceding vehicle and the own vehicle identified by the identifying part and a target distance, and multiplies the adjustment value by the weighted sum to derive the target velocity of the own vehicle.

10. The vehicle control device according to claim 7, wherein the deriving part obtains a weighted sum of a plurality of values, comprising the velocity of the preceding vehicle identified by the identifying part and a difference between the inter-vehicle distance between the preceding vehicle and the own vehicle identified by the identifying part and a target distance, and multiplies the adjustment value by the weighted sum to derive the target velocity of the own vehicle.

11. The vehicle control device according to claim 5, wherein the deriving part obtains a weighted sum of a plurality of values, comprising the velocity of the preceding vehicle identified by the identifying part and a relative velocity of the preceding vehicle and the own vehicle, and multiplies the adjustment value by the weighted sum to derive the target velocity of the own vehicle.

12. The vehicle control device according to claim 7, wherein the deriving part obtains a weighted sum of a plurality of values, comprising the velocity of the preceding vehicle identified by the identifying part and a relative velocity of the preceding vehicle and the own vehicle, and multiplies the adjustment value by the weighted sum to derive the target velocity of the own vehicle.

13. The vehicle control device according to claim 5, wherein the deriving part obtains a weighted sum of a plurality of values, comprising the velocity of the preceding vehicle identified by the identifying part, a difference between the inter-vehicle distance between the preceding vehicle and the own vehicle identified by the identifying part and a target distance, and a relative velocity of the preceding vehicle and the own vehicle, and multiplies the adjustment value by the weighted sum to derive the target velocity of the own vehicle.

14. The vehicle control device according to claim 7, wherein the deriving part obtains a weighted sum of a plurality of values, comprising the velocity of the preceding vehicle identified by the identifying part, a difference between the inter-vehicle distance between the preceding vehicle and the own vehicle identified by the identifying part and a target distance, and a relative velocity of the preceding vehicle and the own vehicle, and multiplies the adjustment value by the weighted sum to derive the target velocity of the own vehicle.

15. A vehicle control method, by which a computer:
identifies a velocity of a preceding vehicle present in front of an own vehicle and an inter-vehicle distance between the preceding vehicle and the own vehicle;
derives an adjustment value, which is a value associated with the identified inter-vehicle distance and decreases as the inter-vehicle distance decreases;
derives a target velocity of the own vehicle based on the derived adjustment value and the identified velocity of the preceding vehicle; and
controls travel of the own vehicle based on the derived target velocity.

16. A vehicle control program, enabling a computer to:
identify a velocity of a preceding vehicle present in front of an own vehicle and an inter-vehicle distance between the preceding vehicle and the own vehicle;
derive an adjustment value, which is a value associated with the identified inter-vehicle distance and decreases as the inter-vehicle distance decreases;
derive a target velocity of the own vehicle based on the derived adjustment value and the identified velocity of the preceding vehicle; and
control travel of the own vehicle based on the derived target velocity.
